(19) United States
(12) Patent Application Publication
(10) Pub. No.: US 2006/0093749 A1
(43) Pub. Date: May 4, 2006

(54) Nanopatterning method

(76) Inventors: Hyoung chul Kim, Seoul (KR); Man Soo Choi, Seoul (KR)

Correspondence Address: David A. Einhorn, Esq.;Anderson Kill & Olick, P.C., 1251 Avenue of the Americas, New York, NY, 10020, US

(21) Appl. No.: 10/977,601

(22) Filed: Oct. 28, 2004

(51) Int. Cl. B05D 1/04

(52) U.S. Cl. 427/458; 427/180; 427/282

(57) ABSTRACT

A nano-sized structure can be accurately patterned with no significant noise generation by the inventive method which comprises the steps of (i) placing a plate having a nano-scale pattern formed thereon on the electrode of an externally grounded electrostatic precipitator and applying a voltage on the electrode, and (ii) introducing bipolar-charged monodispersive nanoparticles into the electrostatic precipitator together with a carrier gas and guiding the migration of the bipolar-charged nanoparticles to said pattern on the plate, by the action of an electric field generated by the applied and grounded voltage difference generated in the electrostatic precipitator.

### FIELD OF THE INVENTION

The present invention relates to a nanopatterning method which generates no significant noise.

### BACKGROUND OF THE INVENTION

The formation of a micro- or nano-sized structure by way of manipulating nanoparticles to selectively adhere to a pre-designed pattern is termed nanopatterning, which can be advantageously used for the manufacture of quantum devices, single electron transistors, tera-level memory devices, high performance gas sensers, etc.

Such nanopatterning has been conventionally performed by guiding nanopaticles to a pattern formed on a plate using a means such as a laser, electronic beam, ion beam, scanning probe microscope tip and metal tip. The conventional method cannot adequately control the great diffusive force of nanoparticles having an average size of less than 100 nm, resulting in the adherence of a significant portion of the nanoparticles to the region beside the formed pattern to generate a noise pattern.

Another conventional nanopatterning method uses an electric microcontact printing technique for transferring a high resolution pattern from a stamp to the surface of a substrate (International Publication WO 02/03142 by Whitesides, G. M. et al.). However, this method is limited to micron-size patterning.

### SUMMARY OF THE INVENTION

Accordingly, it is an object of the present invention to provide a method for nanopatterning without generating a noise pattern by guiding the migration of diffusive nanoparticles in an efficient manner.

In accordance with one aspect of the present invention, there is provided a nanopatterning method comprising the steps of (i) placing a plate having a nano-scale pattern formed thereon on the electrode of an externally grounded electrostatic precipitator and applying a voltage on the electrode, and (ii) introducing bipolar-charged monodispersive nanoparticles into the electrostatic precipitator together with a carrier gas and guiding the migration of the bipolar-charged nanoparticles to said pattern on the plate, by the action of an electric field generated by the applied and grounded voltage difference generated in the electrostatic precipitator.

### BRIEF DESCRIPTION OF THE DRAWINGS

The above and other objects and features of the present invention will become apparent from the following description of the invention, when taken in conjunction with the accompanying drawings, which respectively show:

FIG. 1: a schematic view of the nanopatterning process in accordance with the present invention;

FIG. 2: a schematic diagram of the electrostatic precipitator used in the present invention;

FIGS. 3 and 4: scanning electron microscope (SEM) photographs of the about 1500 nm-sized line structures obtained in Example 1;

FIGS. 5 and 6: SEM and scanning probe microscope (SPM) photographs of the about 100 nm-sized line structures obtained in Example 1; and

FIGS. 7 and 8: SEM and SPM photographs of the sintered 500 nm-diameter dot structures obtained in Example 2.

### DETAILED DESCRIPTION OF THE INVENTION

The nanopatterning of the present invention is characterized in that bipolar-charged monodispersive nanoparticles are introduced into an electrostatic precipitator having an electric field generated by an applied voltage which said particles accurately guide to a desired pattern on a plate.

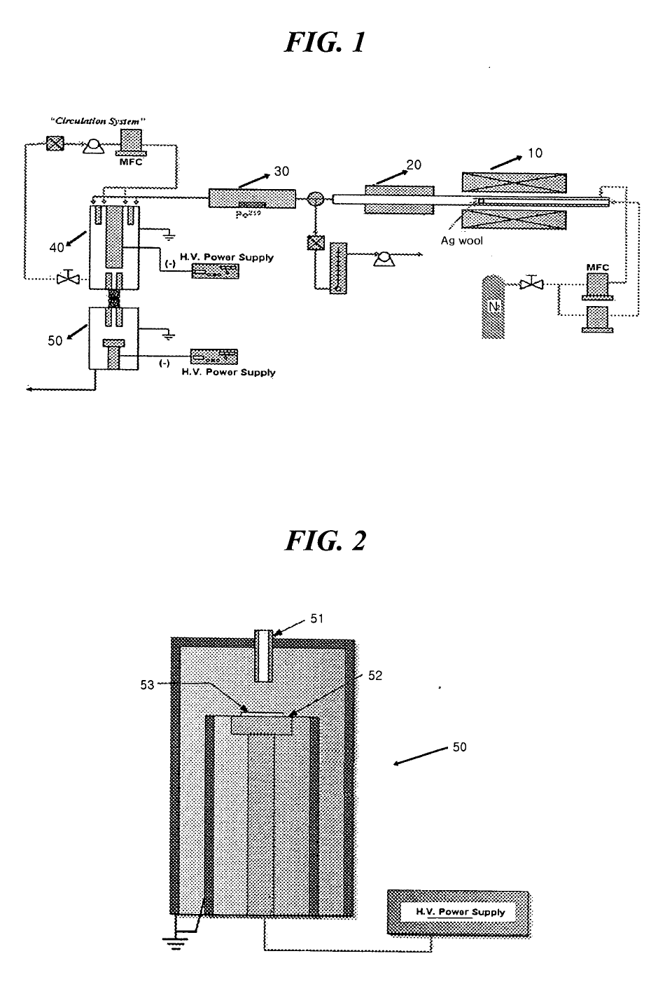

FIG. 1 illustrates the nanopatterning process of the present invention using an externally grounded electrostatic precipitator, which is schematically shown in FIG. 2

Referring to FIG. 1, a conductive material (e.g., Ag wool) is converted into nanoparticles in a tubular reactor, which are then passed to a condenser (20) by the aid of a carrier gas (e.g., nitrogen), to generate polydispersive (i.e., randomly sized) nanoparticle aerosol. The resultant polydispersive nanoparticle aerosol is then passed through a charger (30) to be bipolar-charged using a radioactive element (e.g., polonium). Thereafter, the bipolar-charged polydispersive nanoparticle aerosol is introduced into a differential mobility analyzer (DMA) (40), wherein the voltage applied on the electrode of the DMA is carefully controlled to extract monodispersive (i.e., uniformly sized) nanoparticles from the polydispersive nanoparticles. The aerosol containing monodispersive nanoparticles is then introduced into an electrostatic precipitator for forming nanoparticle patterns.

The electrostatic precipitator (50), as is shown in FIG. 2, is externally grounded and comprises a nozzle (51) located at the top thereof for injecting the aerosol containing monodispersive nanoparticles. The electrode (52) (e.g., made of copper) of the precipitator is insulated. A plate having a pre-designed pattern (53) is placed on the electrode and a voltage is applied on the electrode (52) before the introduction of the aerosol. The voltage applied on the electrode affects the adherence efficiency and accuracy of the nanoparticles on the pattern and it may preferably range from −10 to +10 kV

The pre-designed pattern may be formed on a plate by coating a mask material such as a photoresist on a cleaned plate and etching the coating layer to a desired pattern by lithography. The mask coating layer remaining on the plate is generally removed after the adherence of nanoparticles to the pattern. The photoresist and plate used in the present invention may be of any conventional types.

When the bipolar-charged monodipersive nanoparticle aerosol is introduced into the electrostatic precipitator (50) through the nozzle (51), the nanoparticles are guided to adhere to the pattern on the plate (53) by the action of an electric field generated between the internally applied voltage and the external grounding.

In accordance with the present invention, a nano-sized structure can be patterned without generating any significant noises in a highly efficient manner.

Further, the structure obtained from the inventive method may be annealed at a temperature of 200 to 500° C. for 100 to 150 minutes to reduce the line width of the structure by 10 to 40%.

The present invention is further described and illustrated in Examples provided below, which are, however, not intended to limit the scope of the present invention.

### EXAMPLE 1

Nanopatterning was performed by a process illustrated in FIG. 1 using an electrostatic precipitator illustrated in FIG. 2.

First, a pattern having a line resolution of 100 to 1500 nm was formed on a p-type silicon plate by spin coating a photoresist on a cleaned plate and exposing the photoresist coating layer to ultraviolet or electronic beam-lithograph and removing the exposed region. The patterned plate (53) was placed on copper electrode (52) of electrostatic precipitator (50) and a voltage of −4.5 kV was applied on the copper electrode.

Subsequently, Ag wool was charged in tubular reactor (10) and Ag particles generated therein were passed through a condenser (20) using a nitrogen carrier gas and a sheath gas at a flow rate of 1200 and 890 cc/min, respectively, to generate polydispersive Ag nanoparticle aerosol, which was introduced to bipolar-charger (30) using radioactive 210-polonium and passed through DMA (40) to which a voltage of −810 V was applied, to selectively extract bipolar-charged monodispersive spherical Ag nanoparticles having about 20 nm-diameter (geometric standard deviation: 1.167) from the polydispersive nanoparticles.

Then, the selectively extracted bipolar-charged monodispersive Ag nanoparticle aerosol was introduced into the electrostatic precipitator (50) at a rate of 1000 cc/min to be guided to the plate. Thereafter, the pre-patterned photoresist coating layer remaining on the plate was removed with acetone and ultra pure water. The plate was then cleaned and dried to obtain a nanoparticle assembled micro or nano-sized structure formed thereon.

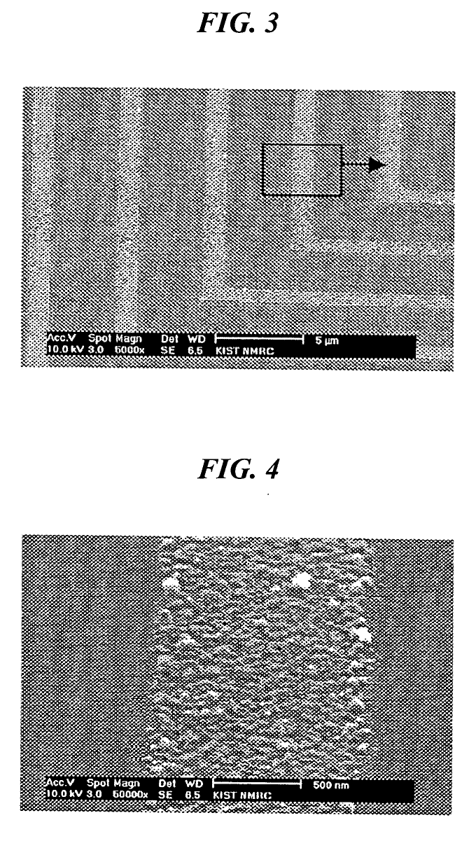

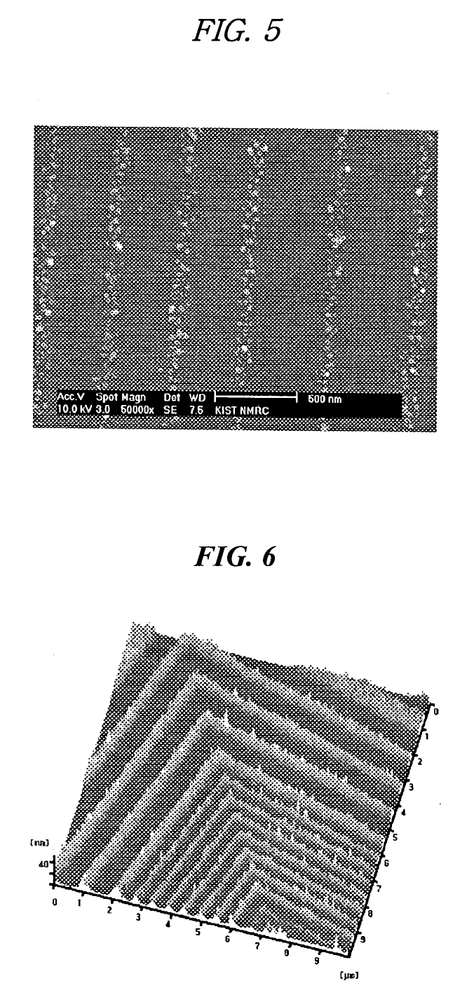

SEM photographs of the nano-scale structure thus formed showed a line resolution of about 1500 nm, as can be seen in FIGS. 3 (low magnitude) and 4 (high magnitude). Also, SEM and SPM photographs of the resultant nano-scale structure having a line resolution of about 100 nm are shown in FIGS. 5 and 6, respectively.

As can be seen in FIGS. 3 to 6, the structure patterned by the inventive method has no significant amounts of particles (noise particles) adhered to the region other than the formed pattern.

### EXAMPLE 2

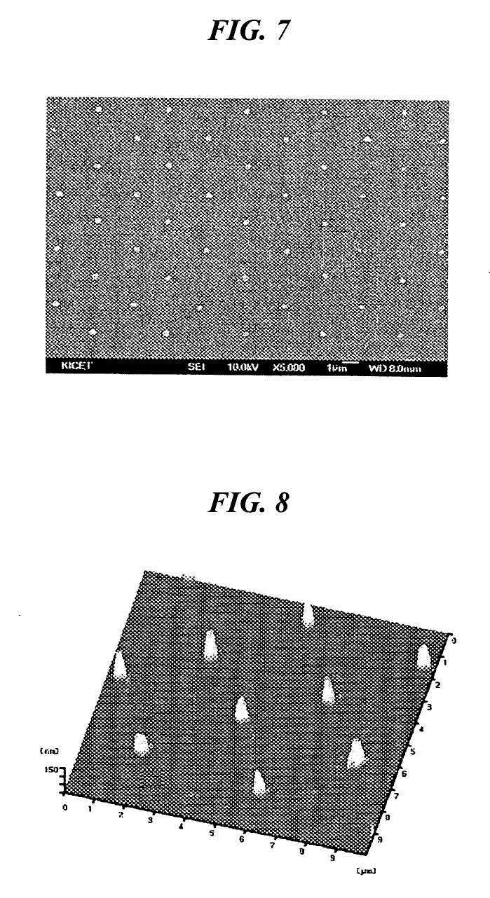

A 500 nm-diameter dot structure obtained by the procedure of Example 1 was annealed at about 400° C. for about 120 minutes to prepare a sintered structure. SEM and SPM photographs of the sintered structure are shown in FIGS. 7 and 8, respectively.

As can seen in FIGS. 7 and 8, the sintered structure prepared by the inventive method has a line resolution of about 300 nm which is higher than that obtainable by a conventional method by 40%.

As described above, in accordance with the present invention, the nanopatterning may be carried out in a high precision and efficiency.

While the invention has been described with respect to the above specific embodiments, it should be recognized that various modifications and changes may be made to the invention by those skilled in the art which also fall within the scope of the invention as defined by the appended claims.

What is claimed is:

1. A nanopatterning method comprising the steps of (i) placing a plate having a nano-scale pattern formed thereon on the electrode of an externally grounded electrostatic precipitator and applying a voltage on the electrode, and (ii) introducing bipolar-charged monodispersive nanoparticles into the electrostatic precipitator together with a carrier gas and guiding the migration of the bipolar-charged nanoparticles to said pattern on the plate, by the action of an electric field generated by the applied and grounded voltage difference generated in the electrostatic precipitator.

2. The method of claim 1, wherein the bipolar-charged monodispersive nanoparticles are obtained by passing a conductive material through a tubular reactor and a condenser using a carrier gas to generate polydispersive nanoparticles; introducing the polydispersive nanoparticles into a charger using radioactive elements to be bipolar-charged; and introducing the bipolar-charged polydispersive nanoparticles into a differential mobility analyzer to extract monodispersive nanoparticles therefrom.

3. The method of claim 1, wherein the voltage applied on the electrode is in a range of −10 to +10 kV.

4. The method of claim 1, which further comprises the step of (iii) annealing the nanopatterned plate after step (ii).

5. The method of claim 4, wherein the annealing step is conducted at a temperature ranging from 200 to 500° C. for 100 to 150 minutes.
